(19) United States
(12) Patent Application Publication
(10) Pub. No.: US 2025/0013881 A1
(43) Pub. Date: Jan. 9, 2025

(54) MACHINE LEARNING ALGORITHM SEARCH USING BINARY PREDICTORS

(71) Applicant: Google LLC, Mountain View, CA (US)

(72) Inventors: Yingjie Miao, Fremont, CA (US); John Dalton Co-Reyes, San Francisco, CA (US); Esteban Alberto Real, Sunnyvale, CA (US); George Jay Tucker, Sunnyvale, CA (US); Aleksandra Faust, Palo Alto, CA (US)

(21) Appl. No.: 18/766,415

(22) Filed: Jul. 8, 2024

Related U.S. Application Data
(60) Provisional application No. 63/512,590, filed on Jul. 7, 2023.

(51) Int. Cl. G06N 5/01; G06N 3/08

(52) U.S. Cl. CPC G06N 5/01; G06N 3/08

(57) ABSTRACT

Methods and systems for receiving training data for a machine learning (ML) task and searching, using the training data, for an optimized component of an ML algorithm for performing the ML task are described.

### CROSS-REFERENCE TO RELATED APPLICATION

This application claims priority to U.S. Provisional Application No. 63/512,590, filed on Jul. 7, 2023. The disclosure of the prior application is considered part of and is incorporated by reference in the disclosure of this application.

### BACKGROUND

This specification relates to searching for components of machine learning algorithms.

Components of a machine learning algorithm can include one or more of an architecture for a machine learning model, an objective function for training the machine learning model, or an optimizer used to update the parameters of the machine learning model based on gradients of the objective function.

For example, neural networks are machine learning models that employ one or more layers of nonlinear units to predict an output for a received input. Some neural networks include one or more hidden layers in addition to an output layer. The output of each hidden layer is used as input one or more other layers in the network, e.g., the next hidden layer or the output layer. Some or all of the layers of the network generate an output from a received input in accordance with current values of a respective set of parameters.

### SUMMARY

This specification describes a system implemented as computer programs on one or more computers in one or more locations that searches for one or more components of a machine learning algorithm for performing a machine learning task.

In particular, the system performs the search using a binary predictor machine learning model. The binary predictor machine learning model is a model that processes respective representations of two components and generates as output a score that indicates whether the first component in the pair would perform better than the second component in the pair on the machine learning task.

The subject matter described in this specification can be implemented in particular embodiments so as to realize one or more of the following advantages.

By searching for a component of a machine learning algorithm using the techniques described in this specification, the system can identify a component that results in a machine learning algorithm that achieves or even exceeds state of the art performance on any of a variety of machine learning tasks, e.g., image classification or another image processing task.

In particular, the system can determine this component significantly faster than existing techniques by making use of a binary predictor machine learning model as described in this specification.

More specifically, by using the binary predictor machine learning model to accept or reject a given candidate based on whether the candidate will outperform its parent, the system can improve the computational efficiency of the search process while maintaining the high quality of the resulting algorithm.

In particular, at any given iteration during an evolutionary search for an algorithm component, some approaches select a parent component from the population and generate a child component by modifying the parent component. These approaches then perform training using a machine learning algorithm that includes the child component to determine how well the machine learning algorithm that includes the child component performs on the task of interest.

However, this training is computationally expensive, particularly when the machine learning algorithm uses a large, state-of-the-art neural network with a large number of parameters. That is, given the size of state-of-the-art neural networks, training using a machine learning algorithm that includes a given child component is extremely computationally expensive, i.e., uses a significant amount of memory and processor cycles, even when the training is not done to convergence.

Instead, the described techniques use the binary predictor machine learning model to accept or reject a given child component based on whether the binary predictor predicts that the child component will outperform its parent component. When a child component is rejected, the system does not perform training using the component. Thus, the described techniques only perform computationally expensive training for components that are likely to be of higher quality than their parents, significantly improving the computational efficiency of the search process while maintaining the high quality of the resulting algorithm.

In other words, by making use of the binary predictor machine learning model during the training to continually score mutations, i.e., modified candidates, until the system finds a candidate that is predicted to have a higher predicted fitness than its parent, the system bypasses wasteful training computation on (likely) lower fitness candidates.

As a result, the described techniques provide large benefits to the evolutionary search in terms of converging more quickly and to a higher fitness over a range of problems. For example, the system can discover competitive or even state-of-the art architectures with a 3.7× speedup when searching for an optimizer for training a neural network and a 4× speedup when searching for a reinforcement learning (RL) loss function relative to current state-of-the-art search techniques, e.g., ones that train each selected candidate.

Moreover, making use of the binary predictor instead of a model that attempts to directly regress a fitness of a candidate results in a search process that generalizes much better to unseen candidates and unseen fitnesses, thereby significantly improving the quality of the component determined using the search. That is, even if another approach uses a model that directly regresses a fitness of a candidate and, e.g., only uses the candidate for training if the regressed fitness is above a specified value, the described approach will nonetheless improve over other approach because the outputs of the described binary predictor will be much more reliable indicators of actual performance, i.e., due to the prediction being a relative prediction rather than a regressed fitness score.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network architecture optimization system.

FIG. 2 is a flow diagram of an example process for searching for a component of a machine learning algorithm.

FIG. 3 is a flow diagram of an example process for selecting another candidate component for evaluation.

FIG. 4 is a flow diagram of another example process for selecting another candidate component for evaluation.

FIG. 5 shows an example of the binary predictor machine learning model.

Like reference numbers and designations in the various drawings indicate like elements.

### DETAILED DESCRIPTION

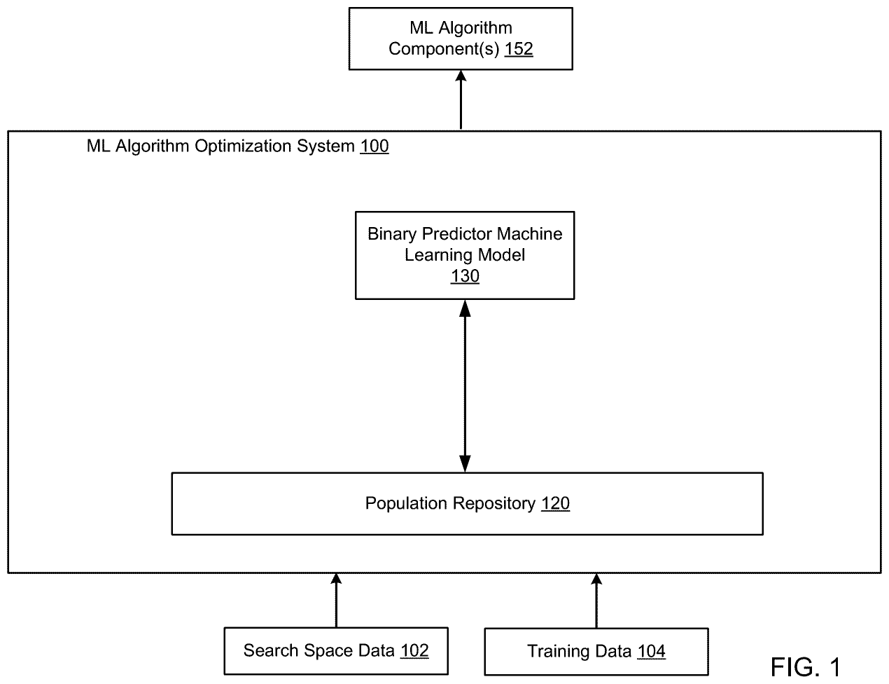

FIG. 1 shows an example machine learning (ML) algorithm optimization system 100. The machine learning algorithm optimization system 100 is an example of a system implemented as computer programs on one or more computers in one or more locations, in which the systems, components, and techniques described below can be implemented.

The system 100 is a system that searches for one or more components 152 of a machine learning algorithm.

A machine learning algorithm is an algorithm that trains a machine learning model to perform a machine learning task, that uses the trained machine learning model to perform the machine learning task, or both.

A component of a machine learning algorithm can be, e.g., an architecture of a machine learning model, an objective function for training the machine learning model, or an optimizer used to update the parameters of the machine learning model based on gradients of the objective function.

More generally, a component of the machine learning algorithm specifies values for a set of one or more hyperparameters of the machine learning algorithm.

A hyperparameter of a machine learning algorithm is any value that is not learned during the training of the machine learning model but that impacts the operation of the machine learning algorithm during training of the machine learning model.

For example, hyperparameters that define the architecture of a model can include values that specify the number of layers in the model and, for each layer, the inputs received by the layer and the operations performed by the layer.

As another example, hyperparameters that define the objective function for training the machine learning model can include values that define the weights assigned to the terms in the objective function and, optionally, values that define the outputs of one or more of the terms of the function. As a particular example, for a reinforcement learning (RL) objective, the hyperparameters can define a loss function (an RL loss) that specifies how rewards received from an environment are used to train a policy neural network for controlling an agent interacting in the environment.

As another example, hyperparameters that define the optimizer used to update the parameters of the machine learning model based on gradients of the objective function can include values that define any other inputs to the optimizer (e.g., one or more moments of the gradients, loss values, and so on) and how the inputs are mapped to parameter updates. An optimizer is a function that, at any given training iteration, maps gradients with respect to the model parameters and, optionally, other inputs, e.g., one or more of current values of the model parameters as of iteration, momentum values for the model parameters, loss function values, and so on, to an update to the current values of the model parameters.

In other words, the system 100 receives search space data 102 that identifies a search space to be searched by the system 100, i.e., that identifies which components of the machine learning algorithm are to be searched by the system 100 and specifies, for any components of the algorithm that are held fixed and not searched by the system 100, the fixed values of the hyperparameters for the component. For any component that is to be searched by the system 100, the search space data 102 also specifies the possible values for the hyperparameters of the component.

For example, the search space data 102 can specify that the system 100 search for an optimizer to be used to train a machine learning model with a fixed architecture on a fixed objective function.

As another example, the search space data 102 can specify that the system 100 search for the architecture of a machine learning model to be trained using a fixed optimizer on a fixed objective function.

As another example, the search space data 102 can specify that the system 100 search for an objective function to be used to train a machine learning model with a fixed architecture with a fixed optimizer.

As yet another example, the search space data 102 can specify that the system 100 search for both an optimizer to be used to train a machine learning model on a fixed objective function and for the architecture of the machine learning model.

As yet another example, the search space data 102 can specify that the system 100 search for the optimizer, the model architecture, and the objective function to be used for the training.

Other combinations of components that are each defined by a respective set of hyperparameters are possible.

The system 100 then performs a search to identify the component(s) 152 specified in the search space data 102 while holding any other components of the algorithm fixed.

Once the system 100 has searched for the component(s) 152, the system 100 can use the component(s) 152 that system 100 discovers by performing the search in any of a variety of ways.

For example, the system 100 can provide data specifying the component(s) 152 to another system for use in training the machine learning model using the machine learning algorithm.

As another example, the system 100 can train a machine learning model in accordance with the component(s) 152 to generate a trained machine learning model. The system 100 can then use the trained machine learning model to process new inputs for the machine learning task. For example, the system 100 can receive inputs to the model from one or more user devices and provide outputs generated by the model to the one or more user devices through an application programming interface (API).

For example, the system 100 can be part of a machine learning as a service system that obtains, e.g., as an upload, training data from a user and then trains a machine learning model using the obtained training data. The machine learning as a service system can then allow the user (or other users) to provide inputs for processing by the trained model and can provide, in response, outputs generated by the trained model.

The description below generally refers to the machine learning model that is trained using the algorithm as being a neural network.

In practice, however, the model can be any appropriate type of machine learning model, e.g., a decision tree, a random forest, a support vector machine, a generalized linear model, and so on.

The neural network that is trained as part of the machine learning algorithm can be configured to receive any kind of digital data input and to generate any kind of score, classification, or regression output based on the input.

In other words, the machine learning task that the machine learning algorithm is used to perform can be any appropriate machine learning task.

Some examples of machine learning tasks now follow.

In some cases, the neural network is a neural network that is configured to perform an image processing task, i.e., receive an input image and to process the input image, e.g., process pixels values of the input image, to generate a network output for the input image.

For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken. The sequence representing the spoken utterance in any of the above may be a digital audio signal or a representation derived from a digital audio signal such as a spectrogram or acoustic features.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an agent control task, where the input is a sequence of observations or other data characterizing states of an environment and the output defines an action to be performed by the agent in response to the most recent data in the sequence and may cause the agent to perform the action. The agent can be, e.g., a real-world or simulated robot, a control system for an industrial facility, or a control system that controls a different kind of agent. The observations may comprise sensor data captured by sensors associated with (e.g., part of) the agent, for example visual data, LIDAR data, sonar data, agent configuration data (e.g., joint angles), agent orientation data, or the like.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

As another example, the task can be a code generation task, where the input is a conditioning input, e.g., a natural language prompt or computer code to be modified or augmented or both, and the output is computer code in a computer programming language that is characterized by the conditioning input.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual natural language understanding tasks, with the network input including an identifier for the individual natural language understanding task to be performed on the network input.

In more detail, to search for the component(s) 152, the system 100 receives training data 104 for the machine learning task.

The system can receive the training data 104 in any of a variety of ways. For example, the system 100 can receive training data as an upload from a remote user of the system over a data communication network, e.g., using an application programming interface (API) made available by the system. As another example, the system 100 can receive an input from the remote user, e.g., through the API, indicating which data set maintained by the system 100 should be used as the training data 104. Similarly, the search space data 102 can be received from the remote user or from another remote user in any of a variety of ways. Alternatively, the search space data 102 can be received as input from an external system or the system 100.

The training data 104 includes a plurality of training inputs and a respective target output for each of the training inputs.

During the search, the system 100 maintains population data 120 that includes, for each candidate component in a population of candidate components, data defining the candidate component and a fitness score for the candidate component that specifies a performance of the candidate component on the machine learning task. Determining the fitness score for a candidate component will be described in more detail below.

The system 100 then repeatedly performs updating iterations until termination criteria are satisfied, e.g., until a threshold number of iterations have been performed or until there are a threshold number of candidates in the population or until the best performing candidate in the population has fitness that satisfies a threshold fitness.

At each iteration, the system updates the population data 120 using a binary predictor machine learning model 130 (“binary predictor”).

The binary predictor 130 is a machine learning model that processes respective representations of a pair of candidate components and generates as output a score that indicates whether the first component in the pair would perform better than the second component in the pair on the machine learning task. For example, the score can be a probability or other likelihood score that represents the predicted likelihood that the first component in the pair performs better than the second component in the pair on the machine learning task.

The binary predictor 130 can generally receive as input any type of representation of a given component that represents the hyperparameter values that specify the given component.

For example, the system 100 can process data defining the given component using an encoder neural network to generate the representation of the given component that is then processed by the binary predictor 130.

The binary predictor 130 can have any appropriate architecture that maps two representations to a score. For example, the binary predictor 130 can be a multi-layer perceptron (MLP) that maps a concatenation of the two representations to the score. As another example, the binary predictor 130 can be a Transformer that maps a sequence of the representations to the score.

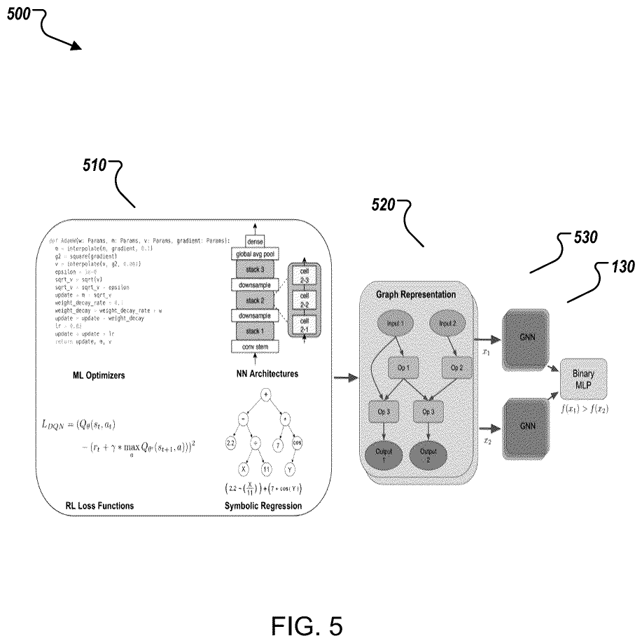

As one example, the data defining the given component can be a graph representation of the given component, i.e., data that represents the component as a graph of nodes and edges. Examples of how to represent various types of components as graphs are described below with reference to FIG. 5.

In this example, the encoder neural network can be a graph processing neural network that processes data representing a graph to generate a representation of the graph as a set of one or more vectors of numeric values.

For example, the encoder neural network can be a graph neural network (GNN) or a graph Transformer neural network.

As a particular example, the encoder neural network can be a GNN that processes respective features of each of the nodes and edges of a graph to generate an embedding that represents the graph. For example, the GNN can encode the features of each node using a node encoder neural network to generate a respective embedding of each node and encode the features of each edge using an edge encoder neural network to generate a respective embedding of each edge. The node and edge encoder neural network can each have any appropriate architecture, e.g., can each be multi-layer perceptrons or Transformer neural networks.

The GNN can then process the node and edge embeddings using one or more graph neural network layers to generate, as output, a respective updated embedding for each node and, optionally, each edge. The GNN can then generate an embedding of the graph from the updated embeddings of the nodes and, optionally, the updated embeddings of each edge using a decoder neural network, e.g., a multi-layer perceptron or a Transformer neural network.

Each graph neural network layer is a layer that receives as input the current embeddings for the nodes and edges and then performs message passing to update the current embeddings for the nodes and, optionally, the current embeddings for the edges.

The graph neural network layers can have any appropriate graph neural network layer architecture. For example, the layers can include any of message passing neural network (MPNN) layers, graph convolutional neural network (GCNN) layers, or graph simulator network (GSN) layers.

Generally, at each updating iteration, the system 100 uses the binary predictor 130 in order to determine which new candidate component(s) to evaluate at the updating iteration, where evaluating a candidate component refers to determining a fitness for the candidate component. Once a candidate component has been evaluated, the system 100 can add data specifying the candidate component and the fitness score for the candidate component to the population of candidate components.

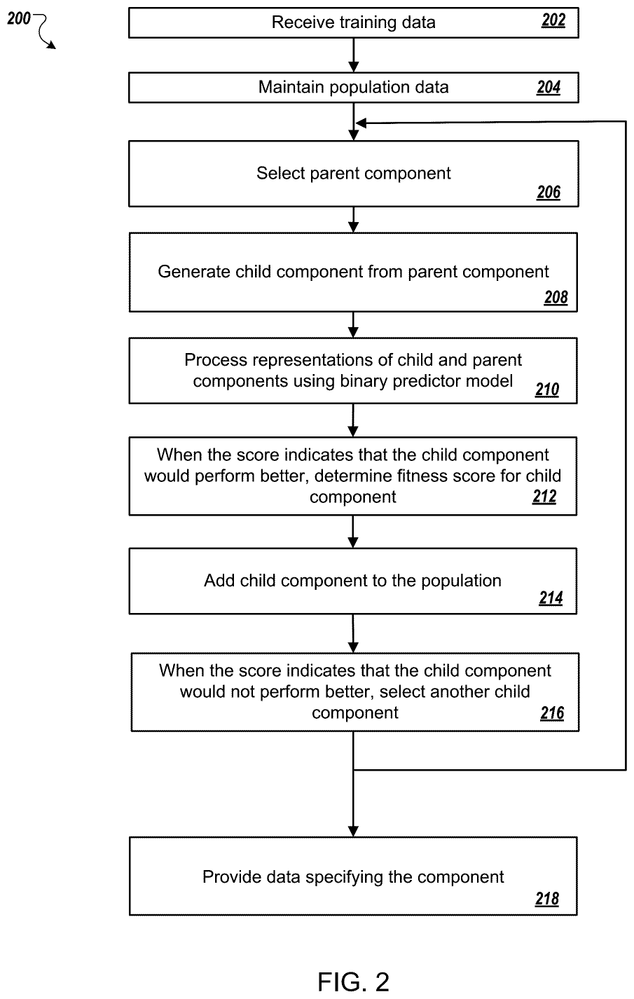

Using the binary predictor 130 to perform updating iterations is described in more detail below with reference to FIGS. 2-5.

Generally, the system 100 trains the binary predictor 130 and, when used, the encoder neural network jointly on a loss function that measures an error, e.g., a binary classification loss or other appropriate error, between the score generated by the binary predictor 130 for a given pair of components and a ground truth score for the given pair of components. For example, the ground truth score for a given pair of components can be equal to one if the first component in the pair has a better actual fitness than the second component in the pair and equal to zero if the first component in the pair does not have a better actual fitness than the second component in the pair.

In some cases, the system 100 performs this training off-line, before beginning the search for the component, e.g., on an existing data set of existing components and associated fitness scores.

In some other cases, however, the system 100 trains the binary predictor 130 and, when used, the encoder neural network jointly online during the search.

For example, at some or all of the updating iterations, the system 100 can train the binary predictor machine learning model using the fitness score for the child component that was evaluated at the updating iteration and the fitness score for the parent component that was used to generate the child component that was evaluated at the updating iteration.

As one example of online training, the system 100 can perform single-process training. In single-process training, the system 100 can alternate between two phases: collecting new samples and training the binary predictor on the samples collected during the preceding collecting phase, which can include a specified number of updating iterations.

As another example of online training, the system 100 can perform distributed training. For example, the system 100 can use asynchronous distributed training to speed up candidate evaluation and model training. In this example, the system can employ a central population server that tracks all the candidates discovered so far while maintaining a population buffer. A single learner periodically syncs new candidate data from the population server and maintain a bounded replay buffer. Once a threshold amount of candidate pairs have been collected within the replay buffer, the learner performs a training step to train the binary predictor 130.

When the encoder neural network is used, the system can jointly train the binary predictor machine learning model 130 and the encoder neural network using the fitness score for the child component and the fitness score for the parent component, e.g., by backpropagating gradients through the binary predictor 130 and into the encoder neural network.

After the termination criteria are satisfied, the system 100 can select a candidate component from the population as the final component 152 to be included in the machine learning algorithm.

FIG. 2 is a flow diagram of an example process 200 for searching for a component of a machine learning algorithm. For convenience, the process 200 will be described as being performed by a system of one or more computers located in one or more locations. For example, a neural network architecture optimization system, e.g., the machine learning algorithm optimization system 100 of FIG. 1, appropriately programmed in accordance with this specification, can perform the process 200.

The system receives training data for a machine learning task (step 202). As described above, the training data generally includes a plurality of training inputs and a respective target output for each of the training inputs.

The system then determines, using the training data, a component of a machine learning algorithm for performing the machine learning task,

To do so, the system maintains population data that includes, for each candidate component in a population of candidate components, data defining the candidate component and a fitness score for the candidate component that specifies a performance of the candidate component on the machine learning task (step 204).

In some cases, the system initializes the population with one or more existing components, e.g., known optimizers, known model architectures, known objective functions, and so on, of algorithms for performing the task.

In some other cases, the system initializes the population with one or more randomly selected components, i.e., components with randomly selected values for each of the hyperparameters of the components.

The system then performs a plurality of updating iterations to update the population.

At each updating iteration, the system selects, as a parent component, a candidate component from the population (step 206).

For example, the system can perform a tournament selection on the candidate components in the population in order to select the parent component. Performing a tournament selection refers to randomly selecting a subset of the population, e.g., a subset that includes a specified fraction of the candidates in the population, and then selecting a candidate from the subset based on the fitness scores for the candidates in the subset. For example, the system can select the candidate with the highest fitness score in the subset. As another example, the system can assign a respective probability to each candidate in the subset based on the fitness score for the candidate and then sample a candidate from the subset in accordance with the respective probabilities.

The system generates a child component by modifying the parent component (step 208).

Generally, to modify the parent component, the system can select one or more of the hyperparameters that define the parent component and then modify the value of each selected hyperparameter.

For example, the system can maintain a set of one or more mutations that each define a modification to one or more corresponding hyperparameters. One example of a mutation is one that switches the value of a corresponding hyperparameter to a randomly selected value from a discrete set of possible values for the corresponding hyperparameter. Another example of a mutation is one that adds or subtracts a fixed or randomly sampled value to the current value of a corresponding hyperparameter. Another example of a mutation is one that multiplies the current value of a corresponding hyperparameter by a fixed or randomly sampled value.

In some cases, the system can then randomly select a mutation from the set and then apply the selected mutation to the parent component.

Alternatively, the system can, for each mutation, select the mutation in accordance with a corresponding probability, and then apply each selected mutation.

Examples of applying modifications to modify various types of parent components are described in more detail in Chris Ying, Aaron Klein, Eric Christiansen, Esteban Real, Kevin Murphy, and Frank Hutter. Nasbench-101: Towards reproducible neural architecture search. In ICML, 2019; John D. Co-Reyes, Yingjie Miao, Daiyi Peng, Esteban Real, Quoc V. Le, Sergey Levine, Honglak Lec, and Aleksandra Faust. Evolving reinforcement learning algorithms. In ICLR, 2021; and Yaofo Chen, Yong Guo, Qi Chen, Minli Li, Wei Zeng, Yaowei Wang, and Mingkui Tan. Contrastive neural architecture search with neural architecture comparators. In CVPR, 2021.

The system processes a representation of the parent component and a representation of the child component using the binary predictor machine learning model to generate a first score that indicates whether the child component would perform better than the parent component on the machine learning task (step 210).

When the first score indicates that the child component would perform better than the parent component on the machine learning task, the system determines a fitness score for the child component (step 212). As described above, the fitness score specifies a performance of the candidate component on the machine learning task.

The fitness score can be any measure that is appropriate for the machine learning task and that measures the performance of a trained neural network on the machine learning task. For example, measures of fitness can include various classification errors, intersection-over-union measures, reward or return metrics, and so on.

To determine the fitness score, the system can train a machine learning model in accordance with the child component of the machine learning algorithm on first subset of the training data and then determine the performance of the trained machine learning model on a second subset of the training data. In some cases, the first and second subsets are predetermined and the same for all candidates. In some other cases, the system randomly divides the training data into the first and second subsets.

The system then updates the population data to include the child component in the population and to associate, with the child component, the fitness score for the child component (step 214).

Optionally, the system can also update the population data to remove a particular candidate component from the population. For example, to regularize the search process, the particular candidate component can be the oldest candidate component in the population, i.e., the particular candidate component that was added to the population least recently.

When the first score indicates that the child component would not perform better than the parent component on the machine learning task, the system selects another candidate component to be evaluated at the updating iteration (step 216).

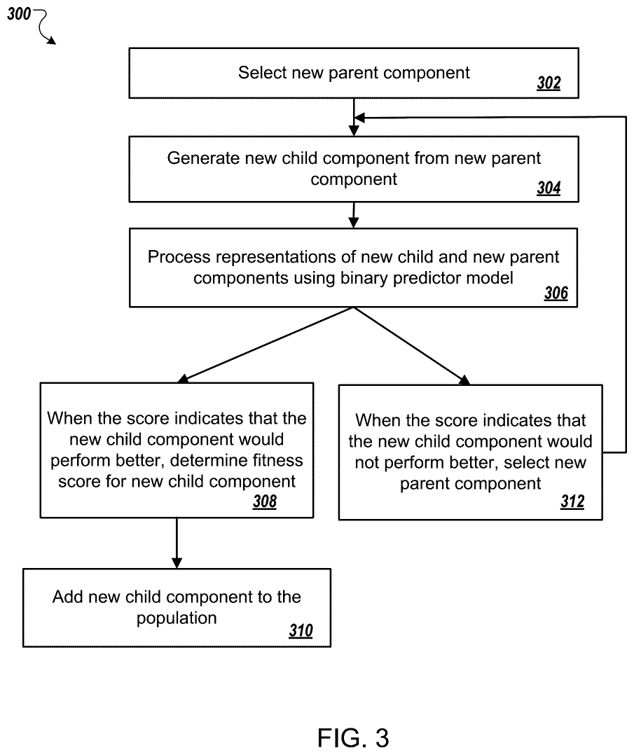

One example technique for selecting another candidate component is described below with reference to FIG. 3.

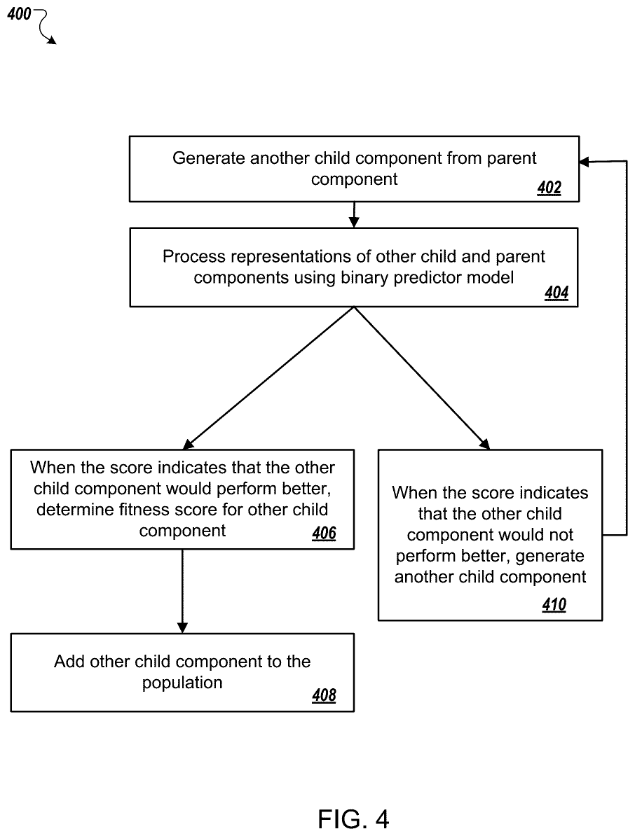

Another example technique for selecting another candidate component is described below with reference to FIG. 4.

In some implementations, at any given updating iteration, the system only performs the steps 206-212 if criteria for randomly generating a new candidate component at the iteration are not satisfied.

For example, the system can randomly sample a value from a specified distribution and then determine that the criteria are satisfied when the value is below a threshold value. Implementing this criterion can assist the system in exploring the entire search space.

As another example, the system can determine that the criteria are satisfied when the population includes fewer than a threshold number of candidate components. Implementing this criterion can ensure that there are sufficient candidates in the population before tournament selection is used to select the parent at a given iteration.

When the criteria for randomly generating a new candidate component at the iteration are satisfied, instead of performing steps 206-212, the system can select a candidate component from the population, e.g., randomly, and then generate a new child component by modifying the selected candidate component, e.g., by applying a mutation to the selected candidate as described above. The system can then determine a fitness score for the new child component without using the binary prediction machine learning model and update the population data to include the new child component in the population and to associate, with the new child component, the fitness score for the new child component.

In some implementations, the system parallelizes the performance of some or all of the operations during the updating iterations across multiple sets of one or more hardware devices. For example, each set of hardware devices can include one or more hardware accelerators for performing machine learning training operations in hardware, e.g., a tensor processing unit (TPU), a graphics processing unit (GPU), or another ASIC, and, optionally, one or more other devices, e.g., CPUs or other devices, that assist the one or more hardware accelerators.

For example, the system can perform an updating iteration by selecting a child component as described above and then providing data specifying the child component to a respective set of one or more hardware devices from the plurality of sets so that the set can evaluate the fitness of the child component. Thus, by generating multiple different child components in parallel, the system can cause multiple different sets to, at any given point during the search, evaluate the fitness of different child components in parallel.

As another example, each set of hardware devices can maintain an instance of the binary predictor model. In this example, each set can asynchronously update the shared population data by independently and in parallel performing updating iterations using the instance of the binary predictor maintained by the set.

Thus, in either of these examples, the system uses the binary predictor to greatly reduce the number of computationally expensive fitness evaluations that need to be performed by the sets of hardware devices during the search while (i) maintaining the quality of the final component that is discovered by the search and (ii) maintaining the parallelizability of the search process. That is, by making use of the binary predictor as described in this specification, the system can reject child components that are unlikely to perform well (and therefore prevent the sets of devices from needing to evaluate the fitnesses of poorly performing child components) and therefore improve the computational efficiency of the search process, particularly when distributed across multiple sets of hardware devices.

After performing the updating iterations, the system provides data specifying one of the components in the population (step 218). For example, the system can select the component in the population that has the highest fitness score.

FIG. 3 is a flow diagram of an example process 300 for selecting another candidate component to evaluate at a given updating iteration. For convenience, the process 300 will be described as being performed by a system of one or more computers located in one or more locations. For example, a neural network architecture optimization system, e.g., the machine learning algorithm optimization system 100 of FIG. 1, appropriately programmed in accordance with this specification, can perform the process 300.

As described above, the system can perform the process 300 when the first score indicates that the child component would not perform better than the parent component on the machine learning task.

In particular, the system selects, as a new parent component, a candidate component from the population (step 302). For example, as described above, the system can perform a tournament selection to select the original parent component for the iteration. To select the new parent component, the system can perform another tournament selection.

The system generates a new child component by modifying the other parent component (step 304), e.g., as described above with reference to step 208.

The system processes a representation of the new parent component and a representation of the new child component using the binary predictor machine learning model to generate a second score that indicates whether the new child component would perform better than the new parent component on the machine learning task (step 306).

When the second score indicates that the new child component would perform better than the new parent component on the machine learning task, the system determining a fitness score for the new child component (step 308) and updates the population data to include the new child component in the population and to associate, with the new child component, the fitness score for the other child component (step 310).

When the second score indicates that the new child component would not perform better than the new parent component on the machine learning task, the system can return to step 302.

Thus, in the process 300, when a given score generated by the binary predictor indicates that a given child component would not perform better than the corresponding parent component on the machine learning task, the system selects a new parent component.

FIG. 4 is a flow diagram of another example process 400 for selecting another candidate component to evaluate at a given updating iteration. For convenience, the process 400 will be described as being performed by a system of one or more computers located in one or more locations. For example, a neural network architecture optimization system, e.g., the machine learning algorithm optimization system 100 of FIG. 1, appropriately programmed in accordance with this specification, can perform the process 400.

As described above, the system can perform the process 400 when the first score indicates that the child component would not perform better than the parent component on the machine learning task.

In particular, the system generates another child component by modifying the parent component (step 402). That is, the system applies a different set of mutations to the parent component to generate another child component from the same parent component. This is in contrast to the process 300, where the system selects a new parent component in order to generate a new child component.

The system process a representation of the parent component and a representation of the other child component using the binary predictor machine learning model to generate a third score that indicates whether the other child component would perform better than the parent component on the machine learning task (step 404).

When the third score indicates that the other child component would perform better than the other parent component on the machine learning task, the system determines a fitness score for the other child component (step 406) and updates the population data to include the other child component in the population and to associate, with the other child component, the fitness score for the other child component (step 408).

When the second score indicates that the other child component would not perform better than the other parent component on the machine learning task, the system can return to step 402.

Thus, in the process 400, when a given score generated by the binary predictor indicates that a given child component would not perform better than the corresponding parent component on the machine learning task, the system attempts to find a better-preforming child from the same parent component.

FIG. 5 shows an example 500 of the binary predictor machine learning model 130.

In particular, as shown in the example 500, the system encodes any of a variety of components 510, e.g., optimizers represented as Python code, neural network architectures, reinforcement learning (RL) loss functions, or symbolic equations, as respective graph representation 520.

The graph representation 520 for a given component represents the component as a graph of nodes and edges, e.g., as a directed acyclic graph (DAG) of nodes and directed edges.

For example, for a neural network architecture, nodes can represent operations and edges can represent define the flow of data between the corresponding operations.

As another example, for an optimizer, the system can parse the optimizer into code in a programming language, e.g., Python or C++, and then represent each line of code as a respective node in the graph, connected by respective directed edges to the nodes representing the preceding and following lines of code.

As another example, for an objective function, e.g., an RL loss function, nodes can represent operations and edges can represent inputs to and outputs of the operations, with one node being designated to represent the final loss.

The system then processes the graph representation 520 of the child component x₁ using an encoder neural network 530 to generate a respective representation of the child component x₁ and the graph representation 520 of the parent component x₂ using the encoder neural network 530 to generate a representation of the parent component x₂. In the example 500, the encoder neural network is a graph neural network (GNN).

The system then processes the representations using a binary prediction machine learning model 130, which, in the example 500, is a multi-layer perceptron (MLP), to generate as output a first score that indicates whether the child component would perform better than the parent component on the machine learning task, i.e., that indicates a likelihood that the fitness score f(x₁) for the child component will be greater than the fitness score f(x₂) for the parent component.

As described above, the system can then use this score to determine whether to evaluate the fitness of the child candidate neural network or to select another candidate neural network for evaluation.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving training data for a machine learning task, the training data comprising a plurality of training inputs and a respective target output for each of the training inputs; and
determining, using the training data, a component of a machine learning algorithm for performing the machine learning task, comprising:
maintaining population data comprising, for each candidate component in a population of candidate components, data defining the candidate component and a fitness score for the candidate component that specifies a performance of the candidate component on the machine learning task,
performing a plurality of updating iterations, wherein each updating iteration comprises performing updating operations comprising:
selecting, as a parent component, a candidate component from the population;
generating a child component by modifying the parent component;
processing a representation of the parent component and a representation of the child component using a binary predictor machine learning model to generate a first score that indicates whether the child component would perform better than the parent component on the machine learning task; and
when the first score indicates that the child component would perform better than the parent component on the machine learning task:
determining a fitness score for the child component; and
updating the population data to include the child component in the population and to associate, with the child component, the fitness score for the child component.

2. The method of claim 1, the updating operations further comprising, when the first score indicates that the child component would perform better than the parent component on the machine learning task:
updating the population data to remove a particular candidate component from the population.

3. The method of claim 2, wherein the particular candidate component is an oldest candidate component in the population.

4. The method of claim 1, the updating operations further comprising:
when the first score indicates that the child component would not perform better than the parent component on the machine learning task:
selecting, as a new parent component, a candidate component from the population;
generating a new child component by modifying the other parent component;
processing a representation of the new parent component and a representation of the new child component using the binary predictor machine learning model to generate a second score that indicates whether the new child component would perform better than the new parent component on the machine learning task;
when the second score indicates that the new child component would perform better than the new parent component on the machine learning task:
determining a fitness score for the new child component; and
updating the population data to include the new child component in the population and to associate, with the new child component, the fitness score for the new child component.

5. The method of claim 4, wherein selecting, as a parent component, a candidate component from the population comprises:
performing a first tournament selection on the population to select the parent component, and wherein
selecting, as a new parent component, a candidate component from the population, comprises:
performing a second tournament selection on the population to select the new parent component.

6. The method of claim 1, the updating operations further comprising:
when the first score indicates that the child component would not perform better than the parent component on the machine learning task:
generating another child component by modifying the parent component;
processing a representation of the parent component and a representation of the other child component using the binary predictor machine learning model to generate a third score that indicates whether the other child component would perform better than the parent component on the machine learning task;
when the third score indicates that the other child component would perform better than the parent component on the machine learning task:
determining a fitness score for the other child component; and
updating the population data to include the other child component in the population and to associate, with the other child component, the fitness score for the other child component.

7. The method of claim 1, wherein determining a fitness score for the child component comprises:
training a machine learning model in accordance with the child component of the machine learning algorithm on first subset of the training data; and
determining a performance of the trained machine learning model on a second subset of the training data.

8. The method of claim 1, the updating operations further comprising:
processing data defining the parent component using an encoder neural network to generate the representation of the parent component; and
processing data defining the child component using the encoder neural network to generate the representation of the child component.

9. The method of claim 8, wherein:
the data defining the parent component is a graph representation of the parent component; and
the data defining the child component is a graph representation of the child component.

10. The method of claim 9, wherein encoder neural network is a graph processing neural network.

11. The method of claim 10, wherein the encoder neural network is a graph neural network or a graph Transformer neural network.

12. The method of claim 1, the updating operations further comprising:
training the binary predictor machine learning model using the fitness score for the child component and a fitness score for the parent component.

13. The method of claim 12, wherein the updating operations further comprising:
processing data defining the parent component using an encoder neural network to generate the representation of the parent component; and
processing data defining the child component using the encoder neural network to generate the representation of the child component, and wherein:
training the binary predictor machine learning model using the fitness score for the child component and a fitness score for the parent component comprises:
jointly training the binary predictor machine learning model and the encoder neural network using the fitness score for the child component and the fitness score for the parent component.

14. The method of claim 1, the updating operations further comprising:
determining whether criteria for randomly generating a new candidate component are satisfied; and
only performing the selecting, generating, processing, determining, and updating of claim 1 when the criteria are not satisfied.

15. The method of claim 14, the updating operations further comprising:
when the criteria are satisfied:
selecting a candidate component from the population;
generating a new child component by modifying the selected candidate component;
determining a fitness score for the new child component without using the binary prediction machine learning model; and
updating the population data to include the new child component in the population and to associate, with the new child component, the fitness score for the new child component.

16. The method of claim 14, wherein the criteria are satisfied when the population includes fewer than a threshold number of candidate components.

17. The method of claim 14, wherein the criteria are satisfied when a value sampled from a specified distribution is below a threshold value.

18. The method of claim 1, wherein the component of the machine learning algorithm for performing the machine learning task comprises an architecture for a machine learning model to be trained to perform the machine learning task.

19. The method of claim 1, wherein the component of the machine learning algorithm for performing the machine learning task defines an objective function for training a machine learning model to perform the machine learning task.

20. The method of claim 1, wherein the component of the machine learning algorithm for performing the machine learning task defines an optimizer for training a machine learning model to perform the machine learning task.

21. The method of claim 1, wherein the component of the machine learning algorithm for performing the machine learning task defines one or more hyperparameters for training a machine learning model to perform the machine learning task.

22. The method of claim 1, further comprising:
providing data specifying the component for use in training a machine learning model.

23. The method of claim 1, further comprising:
training a machine learning model in accordance with the component.

24. A system comprising one or more computers and one or more storage devices storing instructions that are operable, when executed by the one or more computers, to cause the one or more computers to perform operations comprising:
receiving training data for a machine learning task, the training data comprising a plurality of training inputs and a respective target output for each of the training inputs; and
determining, using the training data, a component of a machine learning algorithm for performing the machine learning task, comprising:
maintaining population data comprising, for each candidate component in a population of candidate components, data defining the candidate component and a fitness score for the candidate component that specifies a performance of the candidate component on the machine learning task,
performing a plurality of updating iterations, wherein each updating iteration comprises performing updating operations comprising:
selecting, as a parent component, a candidate component from the population;
generating a child component by modifying the parent component;
processing a representation of the parent component and a representation of the child component using a binary predictor machine learning model to generate a first score that indicates whether the child component would perform better than the parent component on the machine learning task; and
when the first score indicates that the child component would perform better than the parent component on the machine learning task:
determining a fitness score for the child component; and
updating the population data to include the child component in the population and to associate, with the child component, the fitness score for the child component.

25. One or more non-transitory computer storage media encoded with instructions that, when executed by one or more computers, cause the one or more computers to perform operations comprising:
receiving training data for a machine learning task, the training data comprising a plurality of training inputs and a respective target output for each of the training inputs; and
determining, using the training data, a component of a machine learning algorithm for performing the machine learning task, comprising:
maintaining population data comprising, for each candidate component in a population of candidate components, data defining the candidate component and a fitness score for the candidate component that specifies a performance of the candidate component on the machine learning task,
performing a plurality of updating iterations, wherein each updating iteration comprises performing updating operations comprising:
selecting, as a parent component, a candidate component from the population;
generating a child component by modifying the parent component;
processing a representation of the parent component and a representation of the child component using a binary predictor machine learning model to generate a first score that indicates whether the child component would perform better than the parent component on the machine learning task; and
when the first score indicates that the child component would perform better than the parent component on the machine learning task:
determining a fitness score for the child component; and
updating the population data to include the child component in the population and to associate, with the child component, the fitness score for the child component.
